(19) United States
(12) Patent Application Publication
(10) Pub. No.: US 2025/0382046 A1
(43) Pub. Date: Dec. 18, 2025

(54) UNMANNED AIRCRAFT

(71) Applicant: Droneliner LTD, London (GB)

(72) Inventor: Michael John DEBENS, Haverfordwest, Wales (GB)

(73) Assignee: Droneliner LTD, London (GB)

(21) Appl. No.: 18/877,184

(22) PCT Filed: Jun. 19, 2023
(86) PCT No.: PCT/GB2023/051598

§ 371 Date: Dec. 19, 2024

(30) Foreign Application Priority Data
Jun. 30, 2022 (GB) 2209613.5
Oct. 13, 2022 (GB) 2215111.2

(51) Int. Cl. B64C 1/14; B64U 10/25; B64U 20/70; B64U 50/12; B64U 60/55; B64U 70/60; B64U 101/60

(52) U.S. Cl. CPC B64C 1/1415; B64U 10/25; B64U 20/70; B64U 50/12; B64U 60/55; B64U 70/60; B64U 2101/60

(57) ABSTRACT

The disclosure concerns an unmanned aircraft for carrying of cargo, comprising a fuselage (10) extending in a fore-aft direction and configured to receive cargo in an unpressurized interior space thereof; a wing (20) extending in a spanwise direction perpendicular to the fore-aft direction; and a single engine (30) located at or adjacent the rear of the fuselage, wherein the engine (30) is a jet engine. The aircraft is configured for roll-on/roll-off loading of intermodal cargo containers.

### BACKGROUND TO THE INVENTION

The present invention relates to an unmanned aircraft for carrying of cargo.

Vehicles such as ships and aircraft are often used to transport cargo over large distances, and particularly over seas and oceans. Transporting cargo across a large ocean (such as the Atlantic or Pacific) by ship can take up to several weeks. Aircraft can complete the same journey in a matter of hours. However, many aircraft conventionally used to transport cargo have not been specifically designed for this purpose. Instead, the majority of aircraft used to transport cargo were originally designed primarily for passenger travel, and the designs of these aircraft have been subsequently modified to transport cargo. Consequently, these aircraft have been designed and manufactured to meet the needs of human occupants and to provide sufficient seating space. However, it is not typically practical to adapt some aspects of such an aircraft, such as the shape of the fuselage.

As a result, many cargo aircraft are not suitable for transporting freight containers of the type typically used in freight shipping. Instead, many aircraft are used to carry cargo containers which are designed around the shape and size available in aircraft originally designed for passenger travel. Such containers are commonly known as “unit load devices”. As such, aircraft cargo containers are often smaller and have a more complex shape compared to the substantially cuboid intermodal containers used in shipping and other types of cargo. Alternatively, the use of netted cargo on pallets is a common method. Onward transport of the cargo, by truck, ship or rail, therefore requires the cargo to be removed from the unit load device or pallet and transferred to a more standard, cuboid freight container. This process can be time consuming, requiring staff and resources, and may delay the arrival of the cargo at its final destination.

Furthermore, cargo aircraft are typically manned by a crew, including at least two pilots. Consequently, there are several requirements in order to accommodate the crew and ensure their safety. These include the pressurisation of the interior of the fuselage, at least in the cockpit if not throughout the cargo area. Furthermore, these aircraft are provided with multiple engines to provide sufficient thrust and redundancy in case of engine failure. These aircraft therefore require a large number of components, which increases manufacturing and repair time and complexity. Furthermore, the large number of engines increases drag of the aircraft during flight. As such, the aircraft may be less efficient than an aircraft with fewer engines, requiring more fuel to complete the same journey.

For example, the Antonov An-124 is a military cargo aircraft for carrying a payload of over 100,000 kg. The Antonov An-124 is a four-engine aircraft, with the engines being mounted on the main wing. The Antonov An-124 is a manned aircraft, with the crew including a pilot and co-pilot to operate the aircraft from the cockpit during flight.

There is a problem that existing civilian aircraft used to transport cargo were designed for passenger transport and not primarily for transport of cargo. Consequently, there is a problem that transport of cargo is not efficient.

It is an object of the disclosure to provide an aircraft for efficiently transporting cargo.

### SUMMARY OF THE INVENTION

According to an aspect of the invention, there is provided an unmanned aircraft for carrying of cargo. The aircraft comprises a fuselage, a wing and a plurality of jet engines. In particular, the total number of engines may be two (i.e. not more than two). The fuselage extends in a fore-aft direction and is configured to receive cargo in an unpressurized interior space thereof. The aircraft comprises a bottom deck and a top deck above the bottom deck in an interior of the fuselage. The wing extends in a spanwise direction perpendicular to the fore-aft direction. The aircraft is configured for roll-on/roll-off loading of intermodal cargo containers.

According to another aspect of the invention, there is provided an unmanned aircraft for carrying of cargo. The aircraft comprises a fuselage, a wing and a single engine. The fuselage extends in a fore-aft direction and is configured to receive cargo in an unpressurized interior space thereof. The wing extends in a spanwise direction perpendicular to the fore-aft direction. The single engine is a jet engine located at or adjacent the rear of the fuselage. The aircraft is configured for roll-on/roll-off loading of intermodal cargo containers.

The aircraft optionally further comprises a main landing gear comprising a plurality of wheels, and at least one electric motor configured to drive the wheels of the main landing gear.

The aircraft optionally further comprises a battery pack configured to power at least one of said electric motors.

The aircraft optionally further comprises a sled disposed in the fuselage, wherein the battery pack is mounted on the sled, and the sled is configured to move along the fuselage of the aircraft in a fore-aft direction of the fuselage.

Optionally, the sled is controlled to move in a fore-aft direction of the fuselage to vary a centre of gravity position of the aircraft.

Optionally, the underside of the fuselage comprises two protruding sections arranged symmetrically around a centre of the fuselage in the spanwise direction, and a central portion between the protruding sections, wherein the protruding sections extend below a lowermost point of the central portion.

The aircraft optionally further comprises a main landing gear, wherein the protruding sections are configured to house the main landing gear.

Optionally, the protruding sections each comprise a cover configured to extend over the wheels of the main landing gear such that in a closed position the wheels are housed in the protruding section; and wherein the cover is configured to retract such that in an open position the wheels are not completely housed within the protruding section.

Optionally, the cover is configured to be rotated, around longitudinal direction of the protruding section, to move between the open position and the closed position.

Optionally, the main landing gear is non-retractable.

Optionally, an underside of the fuselage is configured as a tunnel hull for landing on water.

The engine is optionally located aft of the fuselage. With the engine being located aft of the fuselage, the drag induced by the aircraft may be reduced compared to an alternative configuration.

The aircraft optionally further comprises an air inlet configured to direct air from a boundary layer of the fuselage into the engine. The air inlet optionally comprises a duct extending around at least 50% of the fuselage in a circumferential direction of the fuselage. The duct may entirely surround the fuselage in a circumferential direction of the fuselage. With these arrangements, boundary layer air formed around the fuselage may be directed into the engine, which may reduce drag and increase efficiency of the aircraft.

The duct optionally comprises an outlet configured to provide a path for air to exit the duct bypassing the engine. The outlet may be configured to close when the aircraft altitude is within an predetermined altitude range. With these arrangements, the engine may operate efficiently during different flight regimes.

The aircraft optionally further comprises a front ramp and a rear ramp. The front ramp may be disposed at a forward end of the aircraft and configured to allow cargo to be loaded into and/or out of the fuselage. The rear ramp may be disposed at the aft end of the fuselage and configured to allow cargo to be loaded into and/or out of the fuselage.

The aircraft optionally further comprises a bottom deck and a top deck in an interior of the fuselage. This top deck is above the bottom deck. The fuselage is optionally configured to house a plurality of standard ISO sized containers on the bottom deck, and a plurality of standard ISO sized containers on the top deck. The rear ramp optionally comprises a pair of rear ramps configured to allow cargo to be loaded out of the top deck and/or the bottom deck. The front ramp optionally comprises a pair of front ramps configured to allow cargo to be loaded into the top deck and/or the bottom deck.

The aircraft optionally further comprises a lifting mechanism. The lifting mechanism is configured to raise the top deck between a lowered position and a raised position. In the lowered position, the top deck is disposed adjacent the bottom deck. In the raised position, the distance between the top deck and the bottom deck is preferably greater than the height of a standard ISO sized container.

The aircraft optionally further comprises a middle deck, wherein the middle deck is disposed above the bottom deck and below the top deck in an interior of the fuselage. The aircraft having a plurality of engines may enable greater amounts of cargo to be transported. For example, the additional engine(s) may provide sufficient thrust for the aircraft to accommodate three decks. Each deck may be configured to accommodate a plurality of standard ISO sized containers.

In an arrangement having a middle deck and a lifting mechanism, the lifting mechanism may be configured to raise the middle deck between a lowered position and a mid-position. In the lowered position, the middle deck is disposed adjacent the bottom deck. In the mid position, the distance between the middle deck and the lower deck is greater than the height of a standard ISO sized container. In the mid position, the distance between the middle deck and the top deck may also be greater than the height of a standard ISO sized container. In other arrangements, the distance between the middle deck and the top deck may be less than the height of a standard ISO container, and/or the distance between the middle deck and the lower deck may be less than the height of a standard ISO container.

The fuselage is optionally configured such that cargo can be loaded into the fuselage via the front ramp, conveyed along the fuselage, and unloaded out of the fuselage via the rear ramp. The aircraft optionally further comprises a track configured to facilitate conveyance of cargo along the fuselage. The track is disposed inside the fuselage on a floor of the fuselage, wherein the track extends in a longitudinal direction of the fuselage. With these arrangements, the cargo may be loaded and unloaded from the aircraft quickly and simply, without the need for complex track switching mechanisms.

The fuselage is optionally configured to house two standard ISO sized containers side-by-side in the spanwise direction. With this arrangement, the cargo may be transported more quickly because the same cargo containers may be used in the aircraft and for road or rail transport.

The aircraft optionally further comprises a wingtip, an electrical generator and a wingtip vortex turbine. The wingtip is at a distal end of the wing. The wingtip vortex turbine is disposed at the wingtip and configured to rotate to turn the electrical generator. The wingtip vortex turbine optionally comprises a plurality of turbine blades, a rod, and a collar. The collar circumferentially surrounds the rod. The collar is configured to slide between a first end of the rod and a second end of the rod, in a longitudinal direction of the rod. The turbine blades each comprise a root and a tip. The collar is connected to the turbine blades at the root of the turbine blades. The wingtip vortex turbine is configured such that, in an deployed position, with the collar at the first end of the rod, the turbine blades extend out from the first end of the rod such that the tips of the turbine blades are a maximum distance from the rod in a radial direction of the rod. The wingtip vortex turbine is configured such that, in a retracted position, with the collar at the second end of the rod, the turbine blades extend alongside the rod such that the tips of the turbine blades are adjacent the first end of the rod. The wingtip optionally comprises a fairing configured to house the turbine blades when the wingtip vortex turbine is in the retracted position. The wingtip vortex turbine may efficiently provide electrical power to aircraft systems.

The wing is optionally disposed in a high wing configuration. The aircraft may further comprise a bracing strut connecting the wing to the fuselage. The bracing strut may contact an underside of the wing at a position in a central region of the wing. The central region may be a central third of the wing between the fuselage and the tip of the wing. The strut may enable an advantageous wing shape to be achieved without undue increase in weight of the aircraft.

The aircraft optionally further comprises a plurality of flight control surfaces, and a plurality of electric motors configured to actuate the control surfaces. Each electric motor may be disposed within a predetermined range of the corresponding flight control surface.

The aircraft optionally further comprises a fuel tank comprising an inner layer and an outer layer surrounding the inner layer. The inner layer is configured to contain fluid. The aircraft optionally further comprises a tank controller configured to control the differential pressure of the outer layer based on fuel tank parameters. Optionally, the fuel tank parameters include rate of fuel flow from the fuel tank and/or pressure in the inner layer. The fuel tank optionally comprises two lobes set fore-and-aft of each other and configured to allow the fluid to travel between the lobes. The tank controller may be configured to control the differential pressure of the outer layer to balance the amount of fluid in each of the two lobes.

The underside of the fuselage optionally comprises two protruding sections and a central portion between the protruding sections. The two protruding sections are arranged symmetrically around a centre of the fuselage the spanwise direction. The two protruding sections extend below a lowermost point of the central portion. The protruding sections are optionally configured to house the main landing gear. An underside of the fuselage may be configured as a tunnel hull for landing on water.

### BRIEF DESCRIPTION OF THE DRAWINGS

The present invention will now be described with reference to exemplary embodiments and the accompanying figures, in which:

FIG. 1A illustrates an example of a front view aircraft with a single engine located at the rear of the fuselage;

FIG. 1B shows the aircraft from the side;

FIG. 2 illustrates an example of a cross-sectional view through A-A of the aircraft of FIG. 1 from the side;

FIG. 3 illustrates an example of a single engine mounted at the rear of the fuselage;

FIG. 4A illustrates an example of loading and unloading cargo on a top deck of the aircraft of FIG. 2;

FIG. 4B illustrates an example of loading and unloading cargo on a bottom deck of the aircraft of FIG. 2;

FIGS. 5A and 5B illustrate comparative example of a cross-sectional view of a known aircraft from the front;

FIG. 5C illustrates an example of a cross-sectional view through B-B of the aircraft of FIG. 1 from the front;

FIG. 6 illustrates the aircraft of FIG. 2 fully loaded with cargo;

FIG. 7A illustrates an example of a wing tip vortex turbine in a deployed position;

FIG. 7B illustrates an example of a wing tip vortex turbine in a retracted position; and

FIG. 8 illustrates an example of a tunnel hull;

FIG. 9 illustrates an example of protruding sections comprising covers;

FIG. 10A illustrates an example of the interior of a lower region of the fuselage, as viewed from above, with battery packs at a position adjacent the corresponding electric motors;

FIG. 10B illustrates an example of a illustrates an example of the interior of a lower region of the fuselage, as viewed from above, with battery packs at a position in the fuselage which is forward of their position in FIG. 10A;

FIG. 11A illustrates an example of a front view of an aircraft with two engines located towards the rear of the fuselage;

FIG. 11B shows the aircraft of FIG. 11A from the side;

FIG. 11C shows the aircraft of FIG. 11A from above;

FIG. 12 illustrates an example of a cross-sectional view through of the aircraft of FIG. 11 from the front;

FIG. 13 illustrates an example of a cross-sectional view through of the aircraft of FIG. 11 from the side;

FIG. 14 illustrates an example of a plan view through of each deck of the aircraft of FIG. 11;

FIG. 15A illustrates an example of a front view of the aircraft of FIG. 11 with the nose open; and

FIG. 15B illustrates an example of a rear view of an aircraft of FIG. 11 with the rear cargo door open.

### DETAILED DESCRIPTION

In an aircraft according to an arrangement of the present disclosure, for example as

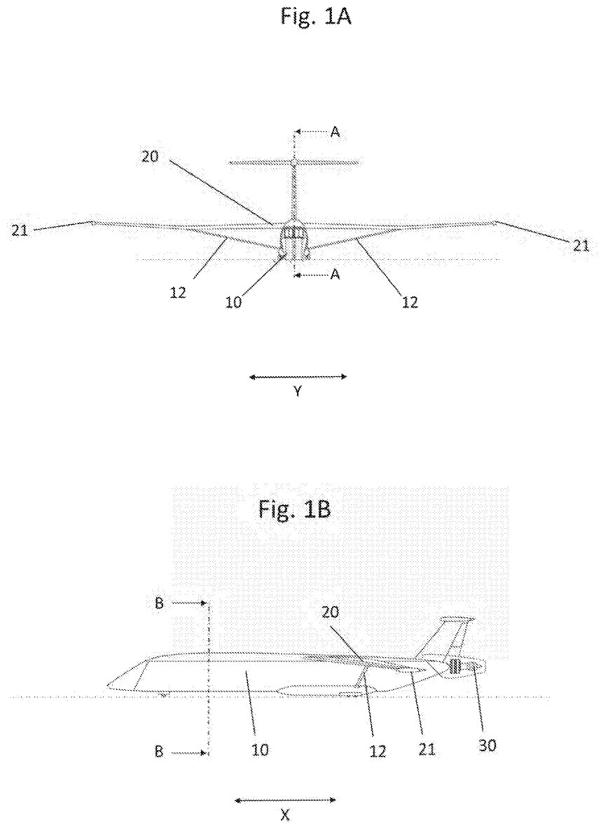

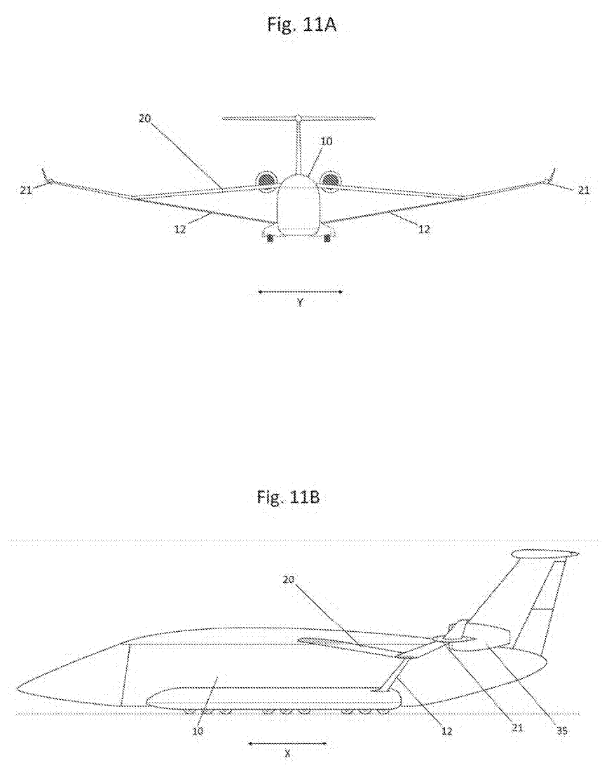

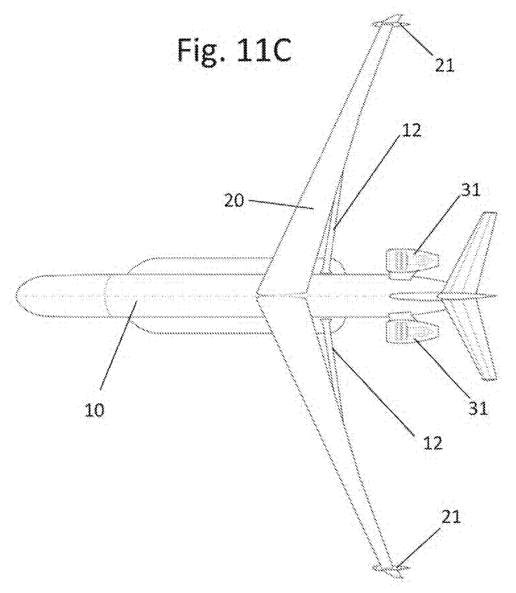

shown in FIG. 1 and FIG. 11, there is an unmanned aircraft for transporting intermodal cargo containers. FIG. 1A provides a front view of an aircraft according to one arrangement, in which the aircraft comprises a single engine, and FIG. 1B provides a side view of the aircraft. FIG. 11A provides a front view of an aircraft according to another arrangement, in which the aircraft comprises two engines, and FIG. 11B provides a side view of the aircraft.

The aircraft is particularly suitable for travelling on trans-oceanic routes. In particular, the aircraft may transport cargo from an origin point, over a sea or ocean to a destination country. At the destination country, the aircraft may land at an airport located at/near the coast. In this way, flying over land, in particular over highly populated areas, may be largely avoided. This may allow a single engine, rather than a plurality of engines, to be provided on the aircraft, because the redundancy provided by multiple engines for flying over populated areas is not required if the aircraft travels principally over water. Alternatively, this may allow the aircraft to have multiple engines, for example two engines, and to carry a greater load than would normally be carried by an aircraft having that number of engines. For example, the aircraft may have sufficient power to complete its flight with all engines operational, but may not be able to do so with an engine failure.

Once the aircraft has arrived at the intended destination airport, the cargo may be readily offloaded. The aircraft is suitable for transporting intermodal cargo containers, having a similar size and shape to those used in rail travel and shipping of freight. Thus, the offloaded intermodal cargo containers can be readily loaded onto a different form of transport for their onward journey, for example by rail over land, to their final destination. In this way, the aircraft may provide a more direct link in the supply chain than alternative aircraft which require purpose built containers or pallets, which are not the same as those used in typical freight for ship and rail travel. In particular, many aircraft cargo containers, for example unit load devices, are designed around the limited space available in many civil aircraft originally designed for passenger travel. As such, aircraft cargo containers are often smaller and have a more complex shape compared to the substantially cuboid containers used in shipping.

The aircraft may therefore replace transport by ship for overseas transport of certain freight. A benefit of using an aircraft rather than a ship is that the cargo may reach its destination within a significantly reduced timeframe compared to traditional shipping.

The aircraft according to one arrangement comprises a fuselage 10, a wing 20, and a single engine 30, for example as shown in FIG. 1A and 1B. The fuselage extends in a fore-aft direction X. The fuselage 10 is configured to receive cargo in an interior space thereof. Preferably, a majority of the interior space of the fuselage is configured to house cargo.

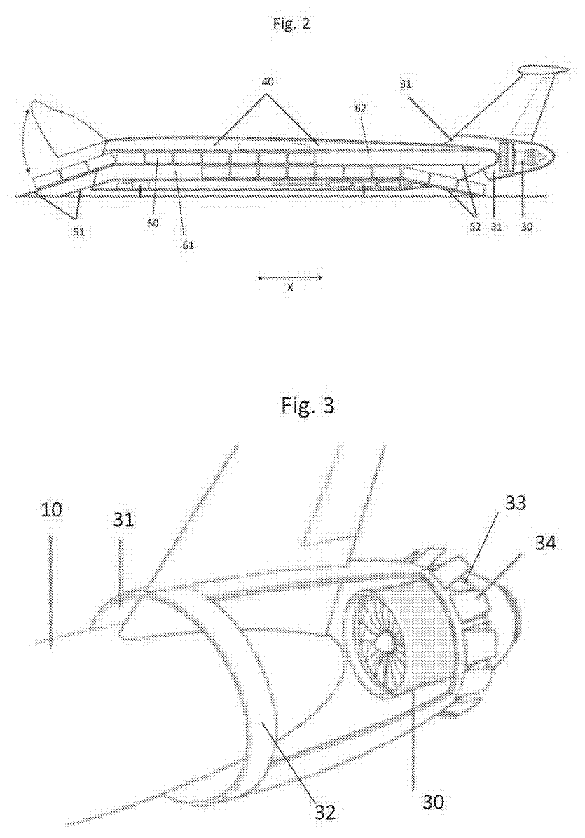

FIG. 2 provides a view of the aircraft of FIG. 1B through cross-section A-A. The aircraft is configured for roll-on/roll-off loading of intermodal cargo containers 50, as shown for example in FIG. 2.

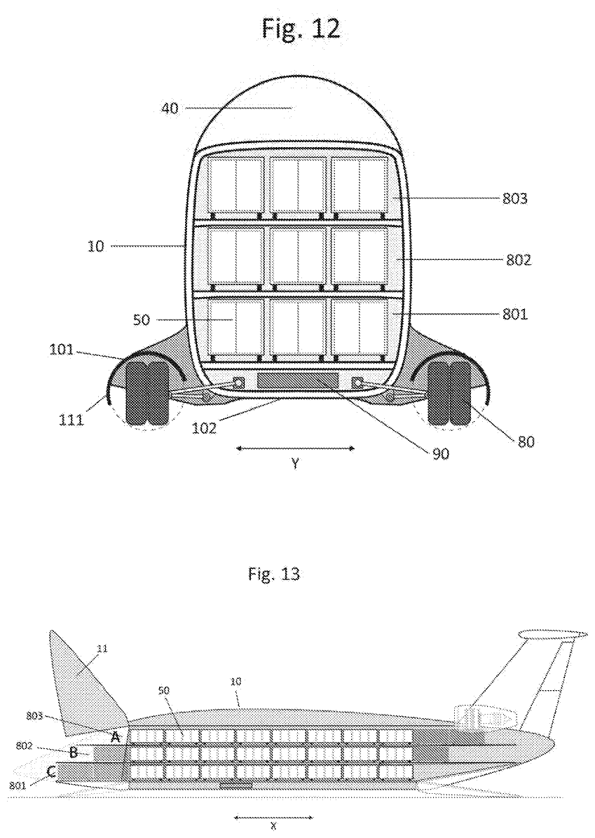

The aircraft is preferably configured such that intermodal cargo containers 50 can be loaded into the fuselage 10, conveyed along the fuselage 10, and unloaded out of the fuselage 10. The cargo may be rolled into and out of the aircraft for example by tracks disposed on a floor of the interior space of the fuselage. The aircraft may be suitable for carrying 50,000 kg of cargo, preferably 100,000 kg, more preferably 200,000 kg, yet more preferably 300,000 kg. In a multi-engine configuration, such as the aircraft having two engines as shown in FIGS. 11 to 15, the aircraft may be suitable for carrying greater loads of cargo than the single engine aircraft, for example 350,000 kg, 400,000 kg or 450,000 kg of cargo, as described further below in relation to FIG. 12.

The interior space of the fuselage is unpressurized. The aircraft is unmanned and therefore does not accommodate crew members or passengers. As such, it is not necessary for the aircraft to be pressurised in flight for the benefit of occupants. The aircraft can therefore be manufactured and operated more cost effectively than an otherwise comparable aircraft requiring pressurisation for the benefit of crew.

As shown for example in FIG. 1A, the wing 20 extends in a spanwise direction Y perpendicular to the fore-aft direction X of the fuselage 10. The wing 20 comprises wingtips 21 at distal ends of the wing 20. In other words, the wingtips 21 are disposed at a position on the wing 20 farthest from the fuselage 10 in a spanwise direction Y perpendicular to the fore-aft direction X.

The wing may be a transonic wing, configured for transonic flight. The wing is preferably a sub-transonic wing, configured for sub-transonic flight. For example, the aircraft may be configured to have a cruising flight speed between Mach 0.6 and Mach 0.9, preferably between Mach 0.7 and Mach 0.8, more preferably Mach 0.75. The wing may be swept back such that the tips of the wing are further aft, in a fore-aft direction X of the fuselage than the root of the wing, where the wing connects to the fuselage.

The engine is a jet engine, and is preferably a turbofan engine. In the arrangement of FIG. 1, a single engine is provided. That is, the aircraft has only one engine, and does not have a plurality of engines (as typically provided on large conventional transport aircraft).

The single engine is located at or adjacent the rear of the fuselage. The single engine is located aft of the wing. The single engine may be located within the aft-most 30% of the fuselage in a fore-aft direction of the fuselage, preferably within the aft-most 20%, more preferably within the aft-most 10%. The aircraft may comprise a tail wing disposed aft of the wing. The tail wing may be located adjacent the rear of the fuselage. The engine may be located at or adjacent the tail wing. The tail is preferably a T-tail. In a T-tail configuration, the tail wing is mounted at or towards the top of a fin which is vertical when the aircraft is level.

In the aircraft illustrated in FIG. 1 and FIG. 2, the engine 30 is located aft of the fuselage 10. It is desirable that the aircraft is arranged with at least some of the engine located behind a rearmost part of the fuselage in an aft direction of the fuselage. Preferably, a central axis of the engine 30 is located aft of the fuselage 20.

With the engine being located aft of the fuselage, the drag induced by the aircraft may be reduced compared to an alternative configuration with the engine disposed offset from the fuselage, for example higher on the tail or atop the fuselage.

As the aircraft is unmanned, there is no need for the aircraft to have multiple engines to provide redundancy in case of engine failure, as provided on conventional large aircraft. The aircraft therefore comprises only one single engine. The engine is preferably disposed at the centre of the aircraft in a spanwise direction Y, perpendicular to the fore-aft direction X of the fuselage. With the engine positioned centrally in a spanwise direction Y, the thrust from the engine promotes even forward motion of the aircraft and reduces the likelihood of thrust being greater on one side of the aircraft than the other in a spanwise direction Y.

A single engine is capable of providing sufficient thrust for the aircraft. For example, the engine may be configured to provide, for example, between 200,000 N and 700,000 N of thrust, preferably between 300,000 N and 600,000 N of thrust, more preferably between 350,000 N and 550,000 N of thrust, yet more preferably between 400,000 N and 500,000 N of thrust. A single engine able to provide sufficient thrust may be more cost effective and induce less drag during flight than a plurality of engines used to provide equivalent thrust. Consequently, the use of a single engine may reduce the cost of both operation and maintenance, and improve fuel efficiency, compared to a multi-engine configuration.

The aircraft preferably comprises an air inlet. The air inlet is configured to direct air into the engine.

During flight a boundary layer (i.e. a slow moving layer of air) may form around surfaces of the aircraft, including the outer surface of the fuselage. The air in the boundary layer adjacent the fuselage surface may move more slowly with respect to the fuselage than the free-stream air flow. Towards the rear of the fuselage, the air flow may be more turbulent than air which is farther away from the aircraft. The air inlet may be configured to direct air within 2 m of the outer surface of the fuselage into the engine, preferably within 1 m, more preferably within 0.5 m.

The air inlet is preferably configured to direct air from the boundary layer of the

fuselage into the engine. In other words, the aircraft is configured to provide air to the engine using boundary layer ingestion. This may have the benefit of reducing the drag associated with the boundary layer.

The air inlet 31 may comprise a duct 32, for example as shown in FIG. 3. FIG. 3 provides a view of the rear of an aircraft comprising an air inlet 31 for directing air to an single engine 30 disposed aft of the fuselage 10. In FIG. 3 the duct 32 is shown with a side panel removed, such that the engine 30 is visible in the figure.

The duct 32 extends fore of the engine, in a fore-aft direction of the fuselage, such that the air inlet is configured to direct air (and in particular boundary layer air) from fore of the engine into the engine. The duct may extend at least 0.5 m fore of the fore-most point of the engine, preferably at least 1 m fore of the engine, more preferably at least 2 m fore of the engine, yet more preferably at least 4 m fore of the engine.

The duct extends at least partially around the fuselage. The duct preferably extends around at least 50% of the fuselage in a circumferential direction of the fuselage. In a preferred arrangement, as shown in FIG. 3, the duct entirely surrounds the fuselage in a circumferential direction of the fuselage. With this arrangement, boundary layer air formed around any point of the fuselage in a circumferential direction of the fuselage may be directed into the engine. Some or all of the boundary layer air formed around the fuselage is provided to the engine instead of continuing to flow along the rear of the fuselage and increasing drag on the aircraft. Providing the engine at or adjacent the rear of the fuselage together with an air inlet to direct boundary layer air into the engine may therefore reduce drag and increase efficiency of the aircraft.

The duct may comprise an outlet configured to provide a path for air to exit the duct bypassing the engine. In other words, the duct may be configured to collect more air than the engine requires to operate at low altitude flight, ejecting the excess air via the outlet. The outlet may be configured to close during specific flight conditions. The outlet is preferably configured to close when the aircraft altitude is within a predetermined altitude range (or when the pressure outside is within a predetermined pressure range corresponding to the pressure at a predetermined altitude in International Standard Atmosphere (ISA) conditions). The outlet may be configured to close automatically when the air density outside the duct is indicative of the altitude reaching the predetermined altitude range.

As shown in the arrangement of FIG. 3, the outlet 33 may comprise flaps 34 configured to open to allow air out of the outlet 33, and to close to prevent air from exiting the duct 32 via the outlet 33. With the flaps closed, air entering the air inlet is directed to the engine. With the flaps 34 open, as shown in FIG. 3, some of the air entering the air inlet 31 is directed to the engine 30 and some of the air is directed out of the duct 32, away from the engine 30, via the outlet 33. The flaps may be configured to close automatically as the pressure drops below the pressure threshold (typically at high altitude, where the air pressure is lower), thus improving air supply to the engine at high altitude.

The predetermined altitude range may be between 6,000 m and 24,500 m (approximately between 20,000 ft and 80,000 ft), preferably between 7,500 m and 23,000 m (approximately between 25,000 ft and 75,000 ft), yet more preferably between 9,000 m and 18,500 m (approximately between 30,000 ft and 60,000 ft) above sea level, or may be an equivalent pressure threshold at International Standard Atmosphere (ISA) conditions.

With this arrangement, the engine can operate efficiently during different flight regimes by being provided with a suitable amount of air depending on the air pressure, and therefore on the altitude of flight.

The aircraft is configured for roll-on/roll-off loading of intermodal cargo containers, similar in size and shape to shipping containers or freight containers. It will be understood that the term “intermodal cargo containers” refers to containers of a standard size which are specifically designed to be used in multiple transport modes, such as rail and road transport, without requiring unloading of the cargo. For the purposes of this disclosure, unit load devices of the type conventionally used for loading aircraft with cargo are not intermodal cargo containers, because they are neither designed for, or used with, other types of transport. Rather, they are filled with cargo for the sole purpose of loading onto an aircraft, and are removed from the unit load containers before being moved to other containers for onward transport (e.g. by road or rail).

The intermodal cargo containers may be substantially cuboid in shape. The intermodal cargo containers may be approximately 1.5 to 3.5 m wide, preferably 2.44 m (8 feet) wide. The height of the intermodal containers may be between 1.5 and 3.5 m, preferably between 2.5 and 3 m, more preferably either 2.59 m (8 feet 6 inches) or 2.9 m (9 feet 6 inches). The intermodal cargo containers may be between 3 and 9 m in length, preferably between 4 and 8 m in length, more preferably between 5 and 7 m in length, yet more preferably 6.1 m (20 feet) in length.

The intermodal cargo containers may have a capacity of one twenty-foot equivalent unit (TEU). Preferably, the intermodal cargo containers are standard ISO sized containers. The standard ISO size is defined by the standard set out in ISO 668 (2020). In this way, the aircraft may be suitable to receive and deliver cargo in the same size of container typically used to deliver freight by road or train. As such, the aircraft is suitable for efficient use in a supply chain comprised of multiple different types of transport. Particularly, the aircraft is suitable for carrying cargo over seas or oceans, for delivery to a land based vehicle, such as a train or road vehicle, for subsequent delivery to the end destination.

The size of the intermodal cargo containers are preferably in accordance with the corresponding ISO standard, as referenced above. The containers are preferably lighter in weight than ISO standard containers. For example, the lightweight intermodal cargo containers may weigh between a sixth and a quarter the weight of a typical ISO standard container, of steel construction. The reduced weight containers may be constructed substantially using, for example, plastic and/or carbon fibre reinforced polymers. The lightweight containers reduce the weight of the payload in the cargo hold of the aircraft, therefore increasing the weight of actual cargo that may be transported in the containers without exceeding the weight loading capabilities of the aircraft.

The fuselage may comprise a cargo hold configured to house a plurality of intermodal cargo containers. The fuselage is preferably configured to house two intermodal cargo containers side-by-side, in a spanwise direction perpendicular to the fore-aft direction of the fuselage. In other words, the fuselage may have a cargo bay with sufficient width to accommodate the width of two intermodal containers next to each other.

The fuselage is preferably configured to house a plurality of intermodal cargo containers arranged fore-and-aft of each other, along the fuselage. In other words, the fuselage may have a cargo bay with sufficient length to accommodate the length of a plurality of intermodal containers disposed end to end, in a lengthwise direction, with each other. Preferably, the fuselage is configured to house between 5 and 20, more preferably between 5 and 15, more preferably between 7 and 13, yet more preferably between 10 and 12 intermodal cargo containers arranged fore-and-aft of each other, along the fuselage. As described above, the fuselage is preferably configured to house two intermodal cargo containers side-by-side in a spanwise direction of the aircraft. The fuselage may therefore be configured to house two rows of intermodal cargo containers. The rows are arranged side-by-side in a spanwise direction of the aircraft. Each row may comprise between 5 and 20 intermodal cargo containers arranged fore-and-aft of each other, along the fuselage. In a preferred arrangement, for example, the fuselage is configured to house two rows of intermodal cargo containers, and each row comprises between 10 and 12 intermodal cargo containers arranged fore-and-aft of each other along the fuselage.

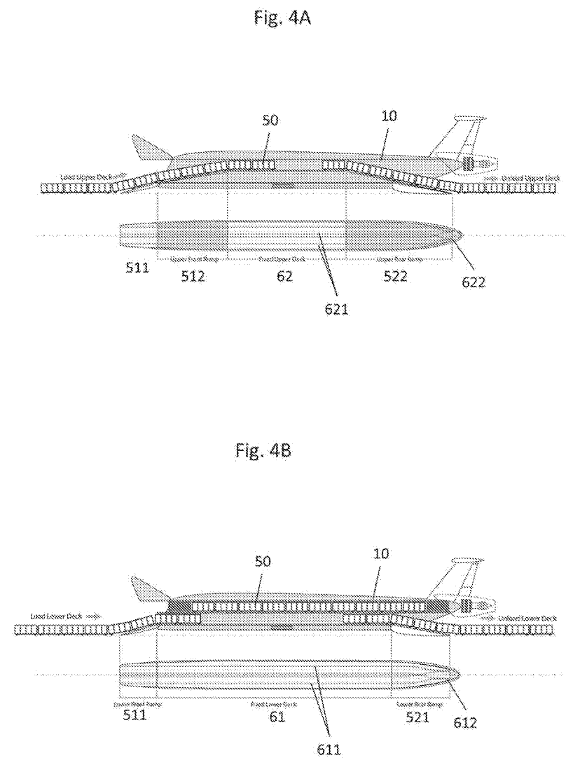

As shown, for example, in FIG. 2 and FIGS. 4A and 4B, the aircraft may comprise a front ramp 51 and a rear ramp 52. The front ramp 51 is disposed at a forward end of the aircraft. The front ramp 51 is configured to allow cargo containers 50 to be loaded into the fuselage 10. Optionally, the front ramp 51 may be configured to allow cargo 50 to be unloaded out of the fuselage 10. The rear ramp 52 is disposed at the aft end of the fuselage and configured to allow cargo 50 to be unloaded out of the fuselage 10. Optionally, the rear ramp 52 may be configured to allow cargo 50 to be loaded into the fuselage 10.

FIG. 5C shows a cross-sectional view of the aircraft of FIG. 1 through section B-B. As shown for example in FIG. 5C, the aircraft may comprise a bottom deck 61 and a top deck 62 above the bottom deck 61 in an interior of the fuselage 10. In other words, the aircraft may comprise a two-floor cargo bay. The fuselage is configured to house a plurality of intermodal cargo containers 50 on the bottom deck 61, and/or a plurality of intermodal cargo containers 50 on the top deck 62. As shown for example in FIG. 5C, the top deck 62 and/or the bottom deck 61 may be configured to house two intermodal cargo containers 50 side-by-side, in a spanwise direction Y perpendicular to the fore-aft direction of the fuselage 10. The top deck and/or the bottom deck are preferably configured to house a plurality of intermodal cargo containers arranged fore-and-aft of each other, along the fuselage, for example as shown in FIG. 2. In a preferred arrangement, the bottom deck 61 and the top deck 62 are each configured to support two rows of intermodal cargo containers. The rows are side-by-side in a spanwise direction of the aircraft and each row extends in a fore-aft direction of the fuselage, as described above.

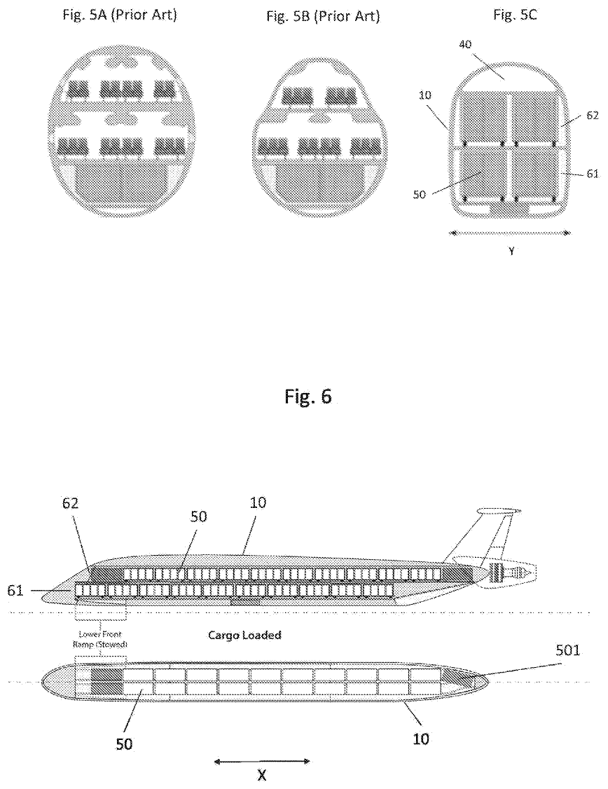

FIG. 6 shows an aircraft fully loaded with intermodal cargo containers 50, viewed from the side. The upper image in FIG. 6 shows a side view of the aircraft and the lower image in FIG. 6 shows the floor of the top deck, in a plan view (as viewed from above). As shown for example in FIG. 6, the top deck 61 may be configured to house more intermodal cargo containers than the bottom deck 61. As shown, the fuselage 10 is configured to accommodate two ISO standard size cargo containers 50 side-by-side, in the spanwise direction of the aircraft, along the majority of the length of the cargo hold. The fuselage 10 may narrow towards the rear of the cargo hold. When the aircraft is loaded with the maximum number of cargo containers 50, the rearmost cargo container 501 may be disposed without an adjacent cargo container, side-by-side with the rearmost cargo container 501 in the spanwise direction of the aircraft. Instead, the rear of the fuselage may be configured to house one ISO standard size cargo container 501 in a spanwise direction of the aircraft.

As shown, for example in FIG. 6, in a preferred arrangement, the fuselage may be configured to house up to between 40 and 48 standard ISO sized containers of 1 TEU capacity. The aircraft may comprise a bottom deck 61 and a top deck 62. Each deck may be configured to support two standard ISO sized containers side-by-side in a spanwise direction of the aircraft. Each deck may be configured to support between 10 and 12 standard ISO sized containers of 1 TEU capacity arranged lengthwise in a fore-aft direction of the fuselage. In other words, each deck may be configured to support two rows of standard ISO sized containers, and each row may comprise between 10 and 12 standard ISO size containers. The aircraft may accommodate a cargo load of 300,000 kg, with the cargo distributed among the intermodal, ISO sized containers. To transport this load, the engine may have a thrust of between 400,000 N and 500,000 N.

FIGS. 5A, B and C show a cross-sectional view of different aircraft. FIG. 5C shows a cross-sectional view of the aircraft of FIG. 1 through section B-B. FIGS. 5A and 5B show a similar cross-sectional view for a known aircraft, as a comparative example. FIGS. 5A and 5B show comparative example aircraft that are designed for passenger transport and not solely for the transport of cargo. As such, the comparative example aircraft have a rounded interior fuselage. In comparison, FIG. 5C shows an aircraft designed for unmanned flight and cargo transport. As such, the interior of the fuselage 10 of the aircraft of FIG. 5C has a comparatively squared-off shape, such that it is configured to accommodate intermodal cargo containers with a square or rectangular cross-section.

FIG. 4A shows cargo being loaded onto the top deck. The upper image in FIG. 4A shows a side view of the aircraft with cargo containers 50 being loaded on to the top deck via the front ramp and unloaded from the top deck via the rear ramp. The lower image in FIG. 4A shows the floor of the top deck in a plan view (as seen from above). FIG. 4B shows cargo being loaded onto the bottom deck. The upper image in FIG. 4B shows a side view of the aircraft with cargo containers 50 being loaded on to the bottom deck via the front ramp and unloaded from the bottom deck via the rear ramp. The lower image in FIG. 4B shows the floor of the bottom deck in a plan view (as seen from above).

As shown, for example, in FIG. 2 and FIGS. 4A and 4B, the rear ramp 52 is preferably configured to allow cargo 50 to be unloaded out of the top deck and/or the bottom deck. The rear ramp 52 preferably comprises a pair of rear ramps. The pair of rear ramps may comprise an upper rear ramp 522 configured to allow cargo 50 to be unloaded out of the top deck. The pair of rear ramps 52 may comprise a lower rear ramp 521 configured to allow cargo 50 to be unloaded out of the bottom deck. Optionally, the pair of rear ramps may be configured to allow cargo to be loaded in to the top deck and/or the bottom deck.

As shown, for example, in FIG. 2 and FIGS. 4A and 4B, the front ramp 51 is preferably configured to allow cargo 50 to be loaded into the top deck and/or the bottom deck. The front ramp 51 preferably comprises a pair of front ramps. The pair of front ramps may comprise an upper front ramp 512 configured to allow cargo to be loaded into the top deck. The pair of front ramps may comprise a lower front ramp 511 configured to allow cargo 50 to be loaded into the bottom deck. Optionally, the pair of front ramps is configured to allow cargo to be unloaded out of the top deck and/or the bottom deck.

Alternatively or additionally to the ramps described above, the aircraft may further comprise a lifting mechanism. The lifting mechanism is configured to raise the top deck between a lowered position and a raised position. In the lowered position, the top deck is disposed adjacent the lower deck. The top deck may be set in the lowered position for loading and unloading of cargo on the top deck. In the raised position, the distance between the top deck and the bottom deck is greater than the height of a standard ISO sized container. The top deck may be set in the raised position in order to load cargo onto the bottom deck. As such, in the raised position there is preferably sufficient vertical distance between the top and bottom decks to accommodate the cargo. The top deck may therefore remain in the raised position during flight. During unloading, the bottom deck may be unloaded first, the top deck may then be lowered, by the lifting mechanism, to the lowered position such that the cargo may be readily unloaded from the top deck. With this arrangement, the length of the ramps and/or steepness of ramps leading to and from the top deck, and the size of the openings are the fore and aft of the fuselage, may be reduced in comparison to an aircraft not including a lifting mechanism to move the deck to a lower position for loading/unloading of the top deck. The lifting mechanism may comprise a jackscrew (also known as a screwjack).

The fuselage is configured such that cargo can be loaded into the fuselage via the front ramp, conveyed along the fuselage, and unloaded out of the fuselage via the rear ramp. The fuselage may comprise a track configured to facilitate conveyance of cargo along the fuselage. The track may be disposed inside the fuselage on a floor of the fuselage. The track preferably extends in a longitudinal direction of the fuselage and is configured to facilitate conveyance of cargo along the fuselage. The track may extend along the entire length of a floor of the cargo hold. The track may extend along the ramps. The track may be provided on both the top deck and the bottom deck of the fuselage.

The track may comprise parallel rails configured to support an intermodal cargo container. The track preferably comprises two sets of parallel rails, extending in the fore-aft direction and disposed side-by-side in a spanwise direction, distributed in a direction which is perpendicular to the fore-aft direction of the fuselage. The track may comprise two sets of parallel rails on the front ramp. The track may comprise two sets of parallel rails extending from the front ramp towards the rear of the fuselage.

Towards the rear of the fuselage, the track may converge from two sets of parallel rails to one set of parallel rails. The track may converge from two sets of parallel rails to a single set of parallel rails on the rear ramp. The single set of parallel rails may be central on the rear of the ramp, distributed in a spanwise direction which is perpendicular to the fore-aft direction of the fuselage. The track may be converged at the rear of the fuselage to conform with a narrower fuselage at the rear ramp than at the front ramp.

As shown, for example, in FIG. 4A, the track may be provided on the top deck 62. The top deck 62 may have a track comprising two sets of parallel rails 621 disposed side-by-side in a spanwise direction. The track may comprise two sets of parallel rails on the upper front ramp 512. The track narrows from two sets of parallel rails 621 to a single set of parallel rails 622 on the upper rear ramp 522.

As shown, for example, in FIG. 4B, the track may additionally be provided on the bottom deck 61. The bottom deck 61 may have a track comprising two sets of parallel rails 611 disposed side-by-side in a spanwise direction. The track may comprise two sets of parallel rails on the lower front ramp 511. The track narrows from two sets of parallel rails 611 to a single set of parallel rails 612 on the lower rear ramp 512.

With this arrangement, an intermodal cargo container may be supported by either of the two sets of parallel rails on the front ramp and loaded into the fuselage. The intermodal cargo container may be conveyed along the majority of the fuselage by the same set of parallel rails. As the intermodal cargo container approaches the rear ramp, or is on the rear ramp, the two sets of parallel rails may narrow to the single set of parallel rails, in order to accommodate narrowing of the fuselage (for, for example, aerodynamic reasons). As the intermodal cargo container is conveyed towards the rear of the fuselage, it is transferred from its initial set of parallel rails to the single set of parallel rails.

Switching means may be employed to transfer the intermodal cargo container from its initial set of parallel rails to the single set of parallel rails. However, the rails are preferably arranged to converge such that an intermodal cargo container will automatically switch from its initial set of rails (of the two sets of parallel rails) to the single set of parallel rails as it is conveyed to the rear of the fuselage. In other words, the track is preferably configured such that the intermodal cargo container can be loaded into the front of the fuselage, conveyed along the fuselage and unloaded off the rear of the fuselage without the need for a switching mechanism to change which set of rails support the intermodal cargo container. This reduces the number of moving components of the track and makes the loading and unloading process simpler, faster and less labour intensive than a more complex system of rails involving complex switching mechanisms.

As shown, for example, in FIG. 1, there are wingtips 21 at the distal ends of the wing 20. The distal ends of the wing are the ends of the wing 20 which are farthest from the fuselage 10. In order to provide electrical power during flight, for example to power flight systems, wingtip vortex turbines may be disposed at one or both of the wingtips. Additionally or alternatively, wingtip vortex turbines may be disposed at the wingtips of the horizontal tail wing. The wingtip vortex turbine is preferably retractable. In particular, it is preferable for any wingtip vortex turbines disposed on wingtips of the main wing to be retractable. Wingtip vortex turbines disposed on the tail wing may be smaller, producing less drag and therefore may be of a simpler, non-retractable configuration. The aircraft may beneficially require less electrical power than manned aircraft, which require electrical power for systems such as flight controls and air conditioning. This further improves the efficiency of the aircraft.

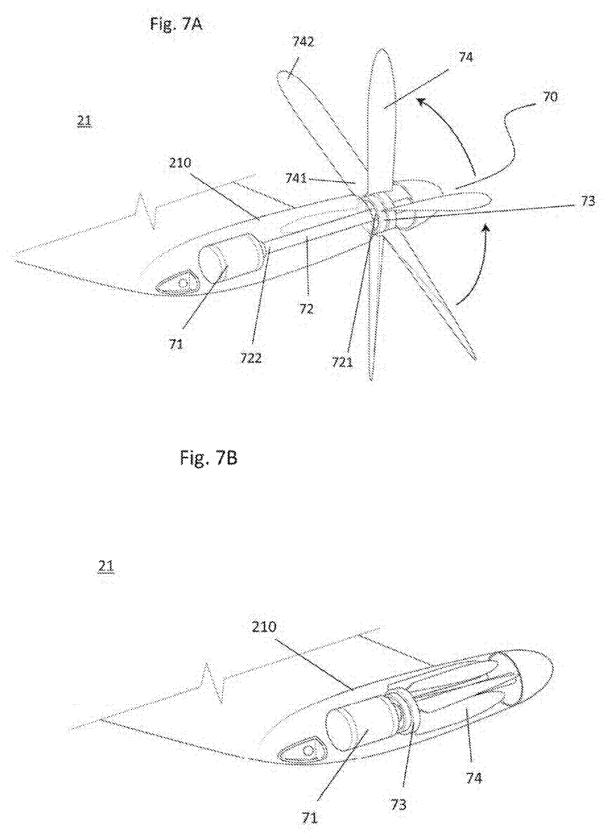

FIGS. 7A and 7B illustrate an example of a retractable wing tip vortex turbine 70. FIG. 7A shows the wingtip vortex turbine in a deployed position and FIG. 7B shows the wingtip vortex turbine in a retracted position. The wingtip vortex turbine 70 of FIGS. 7A and 7B is configured to rotate to turn an electrical generator 71. The electrical generator 71 is preferably also disposed at the wingtip 21. This enables a more direct connection between the wingtip vortex turbine and the electrical generator, saving space and reducing complexity compared to a configuration where the electrical generator is disposed farther from the wing tip vortex turbine.

The wingtip vortex turbine 22 as shown in FIG. 7A, comprises a rod 72, and a collar 73 circumferentially surrounding the rod 72, and turbine blades 74 connected to the collar 73. The collar 73 is configured to slide between a first end of the rod 721 and a second end of the rod 722, in a longitudinal direction of the rod 72. The turbine blades 74 each comprise a root 741 and a tip 742. The collar 73 is connected to the turbine blades 74 at the root of the turbine blades 741.

The wingtip vortex turbine may be configured such that in a deployed position, as shown in FIG. 7A, the collar 73 is at the first end of the rod 721. In this deployed position, the turbine blades 74 extend out from the first end of the rod 721 such that the tips of the turbine blades 742 are a maximum distance from the rod 72 in a radial direction of the rod 72. In other words, in the deployed position, the turbine blades are extended such that they will rotate due to air passing over the wing. In particular, in flight wingtip vortices may form due to the motion of air over the wing of the aircraft. The wingtip vortex turbine may rotate due to these wingtip vortices acting on the turbine blades of the wingtip vortex turbine. The wing tip vortex turbine may therefore improve the efficiency of the aircraft by transforming energy from air flow over the wing into useful power, via the electrical generator.

The wingtip vortex turbine may be configured such that: in a retracted position, as shown in FIG. 7B, the collar 73 is at the second end of the rod 722. In this retracted position, the turbine blades 74 extend alongside the rod 72 such that the tips of the turbine blades 742 are adjacent the first end of the rod 721. In other words, in the retracted position, the turbine blades 74 are not extended out in a radial direction but instead are folded in towards the rod 73. In this position, the air flow over the wing does not act on the turbine blades 74. The drag on the turbine blades may therefore be reduced in this configuration. It may improve efficiency to have the turbine blades retracted during some flight regimes.

The wingtip 21 may comprise a fairing 210 configured to house the turbine blades 74 when the wingtip vortex turbine 70 is in the retracted position as shown in FIG. 7B. The fairing 210 may be shaped to reduce drag on the wingtip. For example, the fairing may have a torpedo or cigar like shape. In this way, the drag on the aircraft during flight with the wingtip vortex turbine housed in the retracted position may be reduced compared to the drag with an unhoused wingtip vortex turbine. The fairing may therefore contribute to the efficiency of the aircraft.

The aircraft comprises a plurality of flight control surfaces configured to be actuated to adjust the aircraft's flight attitude. The control surfaces may include, but are not limited to, a rudder, elevator, and ailerons to adjust the yaw, pitch and roll of the aircraft. The flight control surfaces may be actuated for example using mechanical, hydraulic, or fly-by-wire connection to a main control hub. This arrangement may be similar to a conventional aircraft, where the control surfaces are actuated via a connection to controls in the cockpit.

With an unmanned aircraft, there is no requirement for control commands to be provided via a main control hub, or cockpit. Indeed, the unmanned aircraft need not have a cockpit due to the absence of crew. In particular, it is not essential for there to be a physical connection (such as a mechanical or hydraulic connection or a wire) between the flight control surface and the main control hub. Alternatively, or additionally, discrete actuation mechanisms may be distributed around the aircraft in proximity to the control surfaces. The actuation mechanisms are configured to actuate the control surfaces. The actuation mechanisms may be wirelessly controlled. With this configuration, there may be a reduction in weight and number of components compared to aircraft having a mechanical connection between the control surfaces and a central control hub. This may reduce time and cost during manufacture as well as improving the efficiency of the aircraft in flight.

Preferably, the aircraft may comprise discrete actuation mechanisms in the form of one or more electric motors configured to actuate one or more corresponding control surfaces. Each electric motor is disposed within a predetermined range of the corresponding flight control surface. The predetermined range is preferably 1 m, more preferably, 0.5 m, yet more preferably 0.2 m or less. It is desirable for each electric motor to be disposed as close as possible to the corresponding control surface, so that the control surface may be actuated either directly by the electric motor or via a connector or actuator between the electric motor and the control surface.

The fuselage may comprise a fuselage skin to separate an interior of the fuselage from an exterior of the fuselage. Similarly, the main wing may comprise a wing skin to separate an interior of the fuselage from an exterior of the fuselage. The electric motor may be disposed on an interior side of the skin of the fuselage or wing. The control surface may be adjacent to the corresponding electric motor, and may be disposed on an exterior of the skin of the fuselage or wing. With this arrangement, a connector may be provided through the skin of the fuselage or wing to connect the control surface to the electric motor. In particular, the connector may be configured to facilitate actuation of the control surface by the electric motor. The connector may be a connector rod. The electric motor is preferably disposed such that it is separated from the control surface only by the skin of the fuselage or wing, to reduce the required length of the connector, and thus save weight.

There may be a set of electric motors including a plurality of electric motors corresponding to a single control surface. For example, a large control surface such as the rudder may have a set of corresponding electric motors configured to act in combination to actuate the control surface. The set of electric motors may be collectively controlled to act in unison to actuate the control surface. There may also be a single motor which actuates a plurality of control surfaces.

The aircraft may also comprise retractable landing gear. The landing gear may be configured to be retracted and/or deployed by electric motors disposed in contact with the mounting structure of the landing gear.

The aircraft preferably has a high wing configuration, although it may alternatively have a mid-wing configuration or a low-wing configuration. With the wing disposed in a high wing configuration, the wing is positioned to contact the fuselage at a position towards an upper end of the fuselage in a vertical direction when the aircraft is level. In the high wing configuration the aircraft may comprise a bracing strut 12 connecting the wing 20 to the fuselage 10, as shown for example in FIG. 1. The aircraft may comprise two bracing struts 12, symmetrically arranged on either side of the fuselage 10. Each bracing strut 12 contacts an underside of the wing 20.

Preferably, the bracing strut 12 contacts the wing 20 at a position in a central region of the wing 20. The central region may be between 30% and 85% of the distance between the root of the wing and the wingtip. The root of the wing is the position where the wing meets the fuselage. The central region is preferably between 40% and 80% of the distance between the root of the wing and the wingtip, more preferably between 50% and 75%, yet more preferably between 60% and 70%. For example, the central region may be a central third of the wing, between the fuselage and the tip of the wing. In other words the central region may be between 33% and 67% of the distance between the wing root and the wingtip.

The bracing strut may aid in providing mechanical stability to the wing. The wing and/or the bracing strut may be substantially constructed of lightweight materials, such as fibre glass and/or carbon fibre. The bracing strut may enable an advantageous wing shape to be achieved without undue increase in weight of the aircraft. As such, the bracing strut may contribute to the efficiency of the aircraft and a resulting reduction in fuel expenditure.

The control surfaces of the aircraft may include differential ailerons configured to actuate to roll the aircraft. Differential ailerons may be disposed on the main wing. Alternatively, or additionally, the bracing struts may act as differential ailerons. The bracing struts may be configured to provide lift during flight. In other words, the bracing struts may have an aerodynamic profile, which may be aerofoil shaped. The bracing strut may be configured to twist to change the aerodynamic performance of the bracing strut and contribute to adjusting roll motion of the aircraft. One or more actuation mechanisms, such as electric motors, may be configured to twist the bracing strut. For example, one or more actuation mechanisms may be provided on the interior of the fuselage. The one or more actuation mechanisms may be configured to directly act on the bracing strut to twist the bracing strut, or the one or more actuation mechanisms may be may be connected to the bracing strut via a connector. Preferably, the one or more actuation mechanisms is disposed within the predetermined range of the location on the fuselage where the bracing strut contacts the fuselage.

The aircraft comprises a fuel tank configured to provide fuel to the one or more jet engines. Optionally, the aircraft may comprise a single fuel tank configured to provide fuel to the one or more jet engines. The fuel tank is preferably disposed in an upper part of the interior of the fuselage, in a vertical direction when the aircraft is level. In particular, the fuel tank 40 is preferably disposed above the cargo hold of the fuselage, as shown for example in FIG. 2 and FIG. 4C. The fuel tank may be adjacent to the main wing. The fuel tank may extend fore and/or aft of the main wing in a longitudinal direction of the fuselage. Preferably, the fuel tank extends both fore and aft of the main wing. The fuel tank may therefore have sufficient capacity to facilitate long distance flight routes, such as trans-oceanic routes.

Preferably, the fuel tank is configured to control the distribution of fuel within the fuel tank. More preferably, the fuel tank may be configured to distribute fuel in a fore-and-aft direction (or a longitudinal direction of the fuselage). In this way, the fuel tank may aid in maintaining a desirable centre of gravity position for safe and efficient operation of the aircraft during flight.

The fuel tank may comprise an inner layer configured to contain fluid. The fluid may be any suitable fuel for a jet engine, including conventional kerosene-based jet fuel (such as Jet A or Jet A1), synthetic aviation fuel (SAF), or biofuel. The fuel tank may also comprise an outer layer surrounding the inner layer. The aircraft may comprise a tank controller configured to control the differential pressure of the outer layer based on fuel tank parameters. The fuel tank parameters may include, for example, rate of fuel flow from the fuel tank and/or pressure in the inner layer.

The fuel tank optionally comprises two lobes. The fuel tank is configured to allow the fluid to travel between the lobes. In other words, the two lobes are in fluid communication such that fluid in one lobe can flow to the other lobe, and vice versa. The tank controller is preferably configured to balance the amount of fluid in each of the two lobes. The tank controller may be configured to balance the amount of fluid in each of the two lobes.

The tank controller may be configured to command a fuel pump to force fluid from one lobe into the other lobe. Alternatively, or additionally, the tank controller is configured to control the differential pressure of the outer layer. In this way, the centre of gravity of the aircraft may be maintained. Furthermore, the differential pressure of the outer layer may inhibit fuel from sloshing or surging in the tank.

The two lobes are preferably set fore-and-aft of each other, but may alternatively be set next to each other in a spanwise direction. Furthermore, there may optionally be more than two lobes. For example, there may be four lobes disposed in a grid two lobes wide in a spanwise direction and two lobes long in a for-and-aft direction.

A single fuel tank having an inner and outer layer as described above, may be removed from the aircraft and replaced during maintenance of the aircraft. For example, if the aircraft is re-configured to operate with a new type of fuel, such as pressurised hydrogen gas, the fuel tank may be replaced. The cost of re-fitting the aircraft to adapt to a new type of fuel is therefore relatively low compared to an aircraft with a more traditional configuration, which may have several discrete fuel tanks and an associated network of fuel pipes.

The aircraft is preferably suitable for landing on water. In one arrangement, the aircraft only has one single engine. As such, there is the possibility of engine failure resulting in the aircraft being unable to reach an airport. In particular, due to the likelihood that the aircraft will be operated on mainly trans-oceanic routes (i.e. over water), it is possible that the aircraft may not be able to reach land in the case of an engine failure. Although complete engine failure is rare in modern turbofan engines, it is nonetheless desirable that the aircraft is suitable for landing (ditching) on water, without sustaining significant damage, such that some or all of the cargo may be retrieved and/or the aircraft may be salvaged for future use after ditching in water.

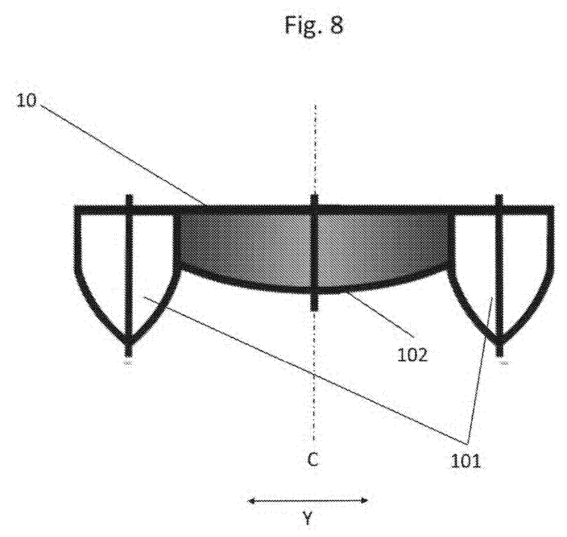

An underside of the fuselage may be configured for landing on water. For example, as shown in FIG. 8, the underside of the fuselage may comprise two protruding sections 101 and a central portion 102 between the protruding sections 101. The protruding sections 101 extend below a lowermost point of the central portion 102 when the aircraft is level. The protruding portions 101 are preferably arranged symmetrically around a centre C of the fuselage 10 in the spanwise direction Y. With this configuration the protruding sections may act as outriggers or sponsons to aid the flotation of the aircraft on water. In other words, during a water landing, the protruding sections may act as hulls. The protruding sections are preferably configured to enclose a ground-effect cushion of air during a water landing. The underside of the aircraft may thus act as a tunnel hull.

The protruding sections are optionally configured to house the main landing gear of the aircraft. In this way, the protruding sections act as both a landing gear housing and a flotation aid for use in the event of a water landing or ditching. Thus, the aircraft may have the benefit of being simpler and more cost effective to manufacture than an aircraft having separate components for housing the landing gear and enabling water landing.

The protruding sections may be shaped such that drag on the aircraft at cruising speed is reduced if the main landing gear is housed in the protruding sections, compared to if the main landing gear were in a deployed position. The protruding sections may preferably therefore contribute to the fuel efficiency of the aircraft.

The main landing gear being housed in the protruding sections when stowed means there does not need to be space within the main body of the fuselage to house the main landing gear. The amount of space within the main body of the fuselage for storing cargo may therefore be greater than in a configuration wherein the main landing gear is housed in the main body of the fuselage.

In an arrangement comprising retractable main landing gear, the main landing gear may be configured to retract into the protruding sections such that the main landing gear is in a stowed position for flight. The main landing gear may also be configured to extend below the protruding portions in a deployed position, such as for taxi, take-off and landing.

In a preferred arrangement, the main landing gear may be fixed rather than retractable. With fixed landing gear, the landing gear is not configured to retract or extend (i.e. is non-retractable). This may provide a configuration which is less mechanically complex and thus lighter and/or more reliable.

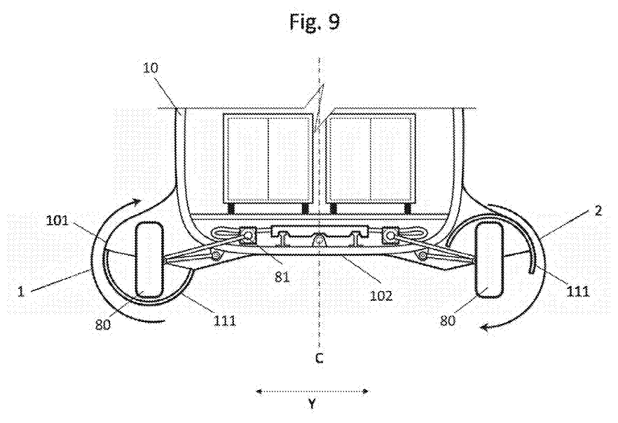

FIG. 9 shows an example of an arrangement with a tunnel hull and a fixed landing gear. The protruding sections 101 each comprise a cover 111 configured to extend over the wheels 80 of the main landing gear. With the cover extended, the wheels 80 are housed in the protruding section in a stowed position, which may also be referred to as a closed position. The cover 111 is also configured to retract such that the wheels 80 are not completely housed within the protruding section 101 in a deployed position, which may also be referred to as an open position. In the open position, the cover 111 may be positioned such that a majority of the cover 111 is disposed within the protruding section 101. In the open position, the lowermost part of the wheels 80 is the lowermost part of the aircraft, when the aircraft is in a wings level orientation. In this way, in the open position, the wheels 80 of the main landing gear are configured to contact the ground during landing.

In the arrangement of FIG. 9, the protruding sections 101 have a partly annular cross-section. In particular, the cover 111 of the protruding section has a partly annular cross-section, for example a semi-circular annular cross-section. With this arrangement, the cover 111 is configured to be rotated, around longitudinal direction of the protruding section (which may be aligned with a fore-aft direction of the aircraft), to move between the open and closed positions. The left side of FIG. 9 shows a closed position, with the cover 111 down and the wheels 80 of the main landing gear housed within the protruding section 101. In order to change from the closed to the open position, the cover 111 is rotated upwards, for example as shown by arrow 1. The right side of FIG. 9 shows an open position, with the cover 111 up inside the protruding section 101 and wheels 80 of the main landing gear partially exposed, for example, for taxi, take-off, or landing. In order to change from the open to the closed position, the cover 111 is rotated, for example as shown by arrow 2. Electrical power, such as from batteries and/or from the wingtip vortex turbines, may be provided to rotate the covers 111 between the open and closed positions.

A small amount of water ingress into the protruding sections 101 may occur during taxi, take-off, and landing during or after heavy rainfall. Furthermore, some water ingress is possible during a water landing. The protruding sections 101 are preferably configured such that, in the closed position, the protruding sections are sealed to resist water from entering the interior of the protruding sections 101. In this way, the protruding sections 101 may be suitable for use as flotation aids for the purpose of landing on water in emergency, for example by acting as the flotation aids of a tunnel hull as explained above with reference to FIG. 8. For example, a seal may be provided between the rotatable cover 111 and a fixed part of the protruding section 101 to resist water ingress. The seal may aid in reducing water ingress, for example during a water landing.

Optionally, one or more pumps, such as a bilge pump, may be provided to eject water from the protruding section 101. In cases where some water entry into the protruding sections occurs, this may prevent waterlogging of the protruding sections. For example, each protruding section 101 may comprise a pump configured to eject water from the protruding section 101. Alternatively, one or more pumps may be provided in the fuselage, each pump being connected to at least one protruding section 101 and configured to eject water from the protruding section 101.

Electronic components (e.g., batteries and motors 81) which are used to power the main landing gear and the rotatable covers 111 are preferably housed inside the fuselage 10. These components may be connected to the interior of the protruding sections 101 by insulated cables and/or flexibly-gaitered driveshafts and/or suspension members. As such, there is a reduced risk that any water which does enter the protruding sections 101, either when they are open or if they are closed and an emergency water landing occurs, will affect the functionality of the electronics.

The main landing gear may be electrically powered. The aircraft may comprise electric motors 81 configured to drive the wheels 80 of the main landing gear. The powered main landing gear is configured to assist in take-off. That is, the motors supplement the propulsion provided by the engine during the take-off roll, which may in turn reduce the power required by the engine. Because the peak power requirement of an engine is typically during take-off, this may in turn allow a smaller engine to be used for a given aircraft. The powered main landing gear is also desirably configured to allow the aircraft to taxi on the ground without need for jet engine power. This may increase efficiency compared to conventional airliners, which are propelled by jet engines during taxi.

The total wheel-power available to the powered main landing gear at take-off is desirably between 3 MW and 9 MW, more desirably between 4.5 MW and 6.7 MW. During take-off, the wheel-power may be capable of providing thrust comparable to, or higher than, that which could be provided by the jet engine. As the speed of the aircraft increases, the thrust provided by the wheel-power will rapidly decrease until it becomes negligible when the aircraft speed is above 185 km/hr, whereupon electrical power to the wheels may be switched off.

The electric motors 81 are preferably fixed in position in the aircraft. The electric motors 81 may be connected to the wheels 80 by drive-shafts, suspension members and/or universal joints. The landing gear are desirably fixed rather than retractable, as discussed above in the description related to FIG. 9. This has the benefit of enabling the electric motors 81 to be fixed in place in the fuselage 10 and to have a simple connection to the wheels 80 compared to the connection mechanisms for retractable landing gear.

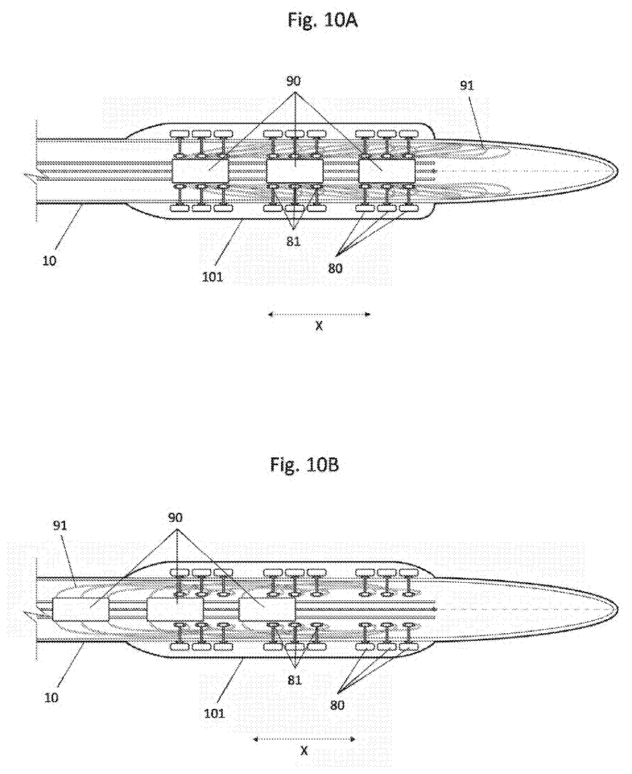

The aircraft may comprise battery packs 90 configured to power the electric motors 81 of the main landing gear. The battery packs 90 may be disposed within the fuselage 10. The battery packs are desirably configured to move along the fuselage 10 in a fore-aft direction of the aircraft. FIGS. 10A and 10B illustrate the interior of a lower region of the fuselage, as viewed from above. In FIG. 10A, the battery packs 90 are in a position adjacent the corresponding electric motors 81, whereas in FIG. 10B, the battery packs 90 are farther forward (to the left in the X direction) in the aircraft. Each battery pack may be mounted on a sled configured to move in a fore-aft direction along the fuselage. The sleds may be controlled to move in a fore-aft direction during flight in order to help maintain the centre of gravity position of the aircraft in flight. One or more cables may be provided to pull the sleds in the fore-aft direction along the fuselage.

The movable battery packs 90 may be electrically connected to the fixed electric motors 81 of the landing gear by connection leads 91. The connection leads 91 are configured to enable the battery packs 90 to move within the fuselage relative to the electric motors 81. In particular, the connection leads 91 may have sufficient length such that there is slack in the connection lead 91 when the battery pack 90 is adjacent its corresponding electric motor(s) 81. Some of this slack in the connection lead 91 can then be taken up as the battery pack 90 moves farther away from its corresponding electric motor(s) 81. The connection lead 91 is flexible, rather than rigid, such that the connection lead 91 does not inhibit the motion of the battery pack 90.

The wingtip vortex turbine, for example as shown in FIG. 7A, may provide electrical power to recharge the batteries during flight.

FIGS. 10A and 10B illustrate the protruding sections 101 and main landing gear as viewed from above. As shown in FIGS. 10A and 10B, the protruding sections 101 are preferably each configured to house a plurality of wheels 80. Each protruding section 101 is preferably configured to house between 6 and 12 wheels, more preferably 9 wheels. The wheels 80 in each protruding section 101 are preferably aligned with each other in a fore-aft direction. The wheels 80 are preferably arranged in wheel groups. Each wheel group has a corresponding, preferably dedicated, electric motor pack and/or battery pack. There may be up to six wheels per wheel group, preferably there are between two and four wheels per wheel group, more preferably there are three wheels per wheel group. In this way an appropriate amount of power can be provided to each wheel group and there is redundancy in case of failure of one electric motor pack and/or battery pack as the wheel groups are each independently powered.

The aircraft optionally comprises a nose landing gear. The nose landing gear of the aircraft is optionally powered, for example by an electric motor and battery pack similar to those described above in reference to the main landing gear. Preferably, the nose landing gear is a conventional, unpowered landing gear. The nose landing gear is not required to contribute to the thrust of the aircraft, and the aircraft may be constructed more simply and cost-effectively using conventional, unpowered nose landing gear.

In some arrangements the nose landing gear may be configured to steer the aircraft, for example during taxiing. In particular, the nose landing gear may be configured to rotate such that the angle of the wheel is changeable relative to the fore-aft direction of the fuselage in order to steer the aircraft during taxiing. Alternatively, or additionally, the main landing gear of the aircraft may be configured to contribute to steering the aircraft. For example, the electric motors of the main landing gear may be controlled to provide different power to wheels on the left of the aircraft than to wheels on the right of the aircraft such that the aircraft turns during taxiing.

Preferably, the main landing gear is configured to steer the aircraft during taxiing (using the differential steering arrangement described above). With this arrangement the aircraft may not comprise nose landing gear, as it is not needed to aid in steering. In other words, the nose landing gear may be omitted. This main landing gear steering arrangement, without nose landing gear, means that an underside of the fuselage does not require a door or opening within which the nose wheel would be housed during flight. The underside of the fuselage may be more resistant to water ingress as there are no doors or openings through which water could readily enter the fuselage. As such, the fuselage may be better suited to aiding flotation during a water landing.

The aircraft according to another arrangement comprises a fuselage 10, a wing 20, and a plurality of engines 35, for example two engines 35 as shown in FIG. 11A, 11B and 11C. The aircraft of FIG. 11 may be the same as that described above in reference to FIGS. 1 to 10, except that the aircraft of FIG. 11 comprises a plurality of engines and is configured to carry a greater amount of cargo than the aircraft of FIGS. 1 to 10. As the arrangement of FIG. 11 comprises a plurality of engines, rather than a single engine directly behind the fuselage, the air inlet of each of the plurality of engines may not include an air inlet configured to direct air from the surface of the fuselage into the engines.

FIG. 12 provides a view of the aircraft of FIG. 11. The aircraft is configured for roll-on/roll-off loading of intermodal cargo containers 50, as shown for example in FIG. 12.

The cargo may be rolled into and out of the aircraft for example by tracks disposed on a floor of the interior space of the fuselage, in a similar manner to that described above in relation to the aircraft arrangement of FIGS. 1, 2 and 4. The aircraft may be suitable for carrying 250,000 kg of cargo, preferably 300,000 kg, more preferably 350,000 kg, yet more preferably 400,000 kg, and yet more preferably 450,000 kg. It will be understood that the provision of two engines, rather than one, may allow greater thrush, and thus greater cargo capacity.

Each of the plurality of engines is a jet engine, and preferably a turbofan engine.

The aircraft preferably comprise two engines. In other words, the aircraft may have only two jet engines. As shown in the arrangement of FIG. 11A-C, the aircraft may have two engines located at or adjacent the rear of the fuselage. The engines 35 are located aft of the wing 20. The engines may be located within the aft-most 30% of the fuselage 10 in a fore-aft (X) direction of the fuselage, preferably within the aft-most 20%, more preferably within the aft-most 10%. The aircraft may comprise a tail wing disposed aft of the wing. The tail wing may be located adjacent the rear of the fuselage. The engines may be located at or adjacent the tail wing. The tail is preferably a T-tail.

The engines are preferably located at a position, such as the rear of the fuselage, other than below the main wing. This arrangement may have the benefit that the engines are less likely to contact the water during a water landing. In other words, the aircraft may be more likely to land safely on water, without one or both engines being one of the first parts of the aircraft to touch the water during a water landing.

As the aircraft is unmanned, there is no need for the aircraft to have enough engines to provide redundancy in case of engine failure, as provided on conventional large aircraft. The aircraft according to this arrangement therefore comprises only two engines despite having a significantly higher payload/cargo capacity than the single engine arrangement of FIGS. 1 to 10. In particular, the unmanned aircraft of FIG. 11 may comprise only two engines while having a payload/cargo capacity more typically found on aircraft having three or more engines.

Similarly to the aircraft described above with reference to FIGS. 1 to 10, the aircraft of FIG. 11A-C is configured for roll-on/roll-off loading of intermodal cargo containers, similar in size and shape to shipping containers or freight containers. As such, the aircraft is suitable for efficient use in a supply chain comprised of multiple different types of transport. Particularly, the aircraft is suitable for carrying cargo over seas or oceans, for delivery to a land based vehicle, such as a train or road vehicle, for subsequent delivery to the end destination.

The fuselage 10 may comprise a cargo hold configured to house a plurality of intermodal cargo containers 50. The fuselage 10 is preferably configured to house three intermodal cargo containers 50 side-by-side, in a spanwise (Y) direction perpendicular to the fore-aft (X) direction of the fuselage 10. In other words, the fuselage 10 may have a cargo bay with sufficient width to accommodate the width of three intermodal containers 50 next to each other, for example as shown in FIG. 12 (which shows a cross-sectional view of the aircraft of FIG. 11A-C).

The fuselage is preferably configured to house a plurality of intermodal cargo containers arranged fore-and-aft of each other, along the fuselage. In other words, the fuselage may have a cargo bay with sufficient length to accommodate the length of a plurality of intermodal containers disposed end to end, in a lengthwise direction, with each other. Preferably, the fuselage is configured to house between 5 and 20, more preferably between 5 and 15, more preferably between 7 and 13, yet more preferably between 10 and 12 intermodal cargo containers arranged fore-and-aft of each other, along the fuselage. As described above, the fuselage is preferably configured to house three intermodal cargo containers side-by-side in a spanwise direction of the aircraft. The fuselage may therefore be configured to house three rows of intermodal cargo containers. The rows are arranged side-by-side in a spanwise direction of the aircraft. Each row may comprise between 5 and 20 intermodal cargo containers arranged fore-and-aft of each other, along the fuselage. In a preferred arrangement, for example, the fuselage is configured to house three rows of intermodal cargo containers, and each row comprises between 10 and 12 intermodal cargo containers arranged fore-and-aft of each other along the fuselage.

As shown, for example, in FIGS. 13, 14 and 15A-B, the aircraft of FIG. 11 may comprise a front ramp 810 and a rear ramp 820. The front ramp 810 is disposed at a forward end of the aircraft. The front ramp 810 is configured to allow cargo containers 50 to be loaded into the fuselage 10. Optionally, the front ramp 810 may be configured to allow cargo 50 to be unloaded out of the fuselage 10. The rear ramp 820 is disposed at the aft end of the fuselage and configured to allow cargo 50 to be unloaded out of the fuselage 10. Optionally, the rear ramp 820 may be configured to allow cargo 50 to be loaded into the fuselage 10.

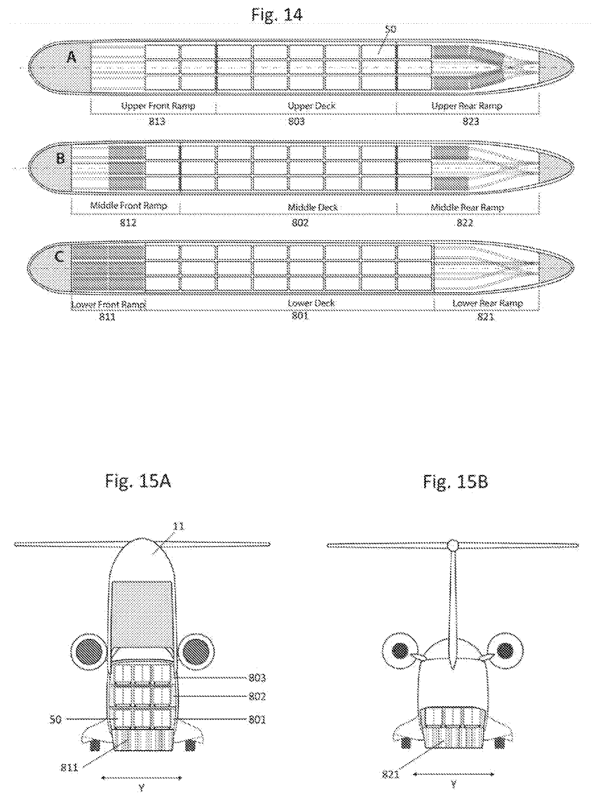

FIG. 12 shows a cross-sectional view of the aircraft of FIG. 11. As shown for example in FIG. 12 the aircraft may comprise a bottom deck 801, a middle deck 802 above the bottom deck 801, and a top deck 803 above the middle deck 802 in an interior of the fuselage 10. In other words, the aircraft may comprise a three-floor cargo bay. The fuselage is configured to house a plurality of intermodal cargo containers 50 on each of the three decks 801, 802, 803. As shown for example in FIG. 2, each of the three decks 801, 802, 803 may be configured to house three intermodal cargo containers 50 side-by-side, in a spanwise direction Y perpendicular to the fore-aft direction of the fuselage 10. Each deck is preferably configured to house a plurality of intermodal cargo containers arranged fore-and-aft of each other, along the fuselage, for example as shown in FIGS. 13 and 14. In a preferred arrangement, each deck is configured to support three rows of intermodal cargo containers. The rows are side-by-side in a spanwise direction of the aircraft and each row extends in a fore-aft direction of the fuselage, as described above.

FIGS. 13 show the aircraft of FIG. 11 fully loaded with intermodal cargo containers 50, viewed from the side. FIG. 14 shows each of the decks of the aircraft of FIG. 13 from above (top image is the upper deck 803, middle image is the middle deck 802, bottom image is the lower deck 801). As shown, for example in FIG. 14, in a preferred arrangement, the fuselage may be configured to house up to between 70 and 90 standard ISO sized containers of 1 TEU capacity. Each deck may be configured to support three standard ISO sized containers side-by-side in a spanwise direction of the aircraft. Each deck may be configured to support between 8 and 12 standard ISO sized containers of 1 TEU capacity arranged lengthwise in a fore-aft direction of the fuselage. In other words, each deck may be configured to support three rows of standard ISO sized containers, and each row may comprise between 8 and 12 standard ISO size containers. The aircraft may accommodate a cargo load of 350,000 kg, with the cargo distributed among the intermodal, ISO sized containers.

As shown, for example, in FIG. 14, the rear ramp 820 is preferably configured to allow cargo 50 to be unloaded out of the upper deck and/or the middle deck and/or the lower deck. The rear ramp 820 preferably comprises a plurality of rear ramps. The plurality of rear ramps may comprise an upper rear ramp 823 configured to allow cargo 50 to be unloaded out of the upper deck. The plurality of rear ramps 820 may comprise a middle rear ramp 822 configured to allow cargo 50 to be unloaded out of the middle deck. The plurality of rear ramps 820 may comprise a lower rear ramp 821 configured to allow cargo 50 to be unloaded out of the lower deck.

As shown, for example, in FIG. 14, the front ramp 810 is preferably configured to allow cargo 50 to be loaded in to the upper deck and/or the middle deck and/or the lower deck. The front ramp 810 preferably comprises a plurality of front ramps. The plurality of front ramps may comprise an upper front ramp 813 configured to allow cargo 50 to be loaded on to the upper deck. The plurality of front ramps 810 may comprise a middle front ramp 812 configured to allow cargo 50 to be loaded on to the middle deck. The plurality of front ramps 810 may comprise a lower front ramp 811 configured to allow cargo 50 to be loaded on to the lower deck.

Alternatively or additionally to the ramps described above, the aircraft may further comprise a lifting mechanism. The lifting mechanism may be configured to raise the upper deck between a lowered position and a raised position. In the lowered position, the upper deck is disposed adjacent the middle deck, and the middle deck may optionally be disposed adjacent to the lower deck. In other words, the distances between adjacent decks may be a minimum distance. The upper deck may be set in the lowered position for loading and unloading of cargo on the upper deck. In the raised position, the distance between the upper deck and the middle deck is greater than the height of a standard ISO sized container. The upper deck may be set in the raised position in order to load cargo onto the middle deck and/or the lower deck. As such, in the raised position there is preferably sufficient vertical distance between the upper and middle decks to accommodate the cargo. The upper deck may therefore remain in the raised position during flight. During unloading, the middle deck may be unloaded prior to lowering and then unloading of the upper deck.

The lifting mechanism may be configured to raise the middle deck between a lowered position and a mid-position. In the lowered position, the middle deck is disposed adjacent the lower deck. The middle deck may be set in the lowered position for loading and unloading of cargo on the middle deck. In the mid position, the distance between the middle deck and the lower deck is greater than the height of a standard ISO sized container. The middle deck may be set in the mid position in order to load cargo onto the lower deck. As such, in the mid position there is preferably sufficient vertical distance between the middle and lower decks to accommodate the cargo. The middle deck may therefore remain in the mid position during flight. During unloading, the lower deck may be unloaded prior to lowering the middle deck to the lower position and then unloading the middle deck.

With the lifting mechanism, the length of the ramps and/or steepness of ramps leading to and from the upper deck, and the size of the openings are the fore and aft of the fuselage, may be reduced in comparison to an aircraft not including a lifting mechanism to move the deck to a lower position for loading/unloading of the upper deck. The lifting mechanism may comprise a jackscrew (also known as a screwjack).

FIG. 15A provides a front view of the aircraft showing the fore opening, which allows cargo into the fuselage, in an open position. As shown in FIG. 15A, the fore opening may comprise a nose 11 configured to swing open to enable cargo to be loaded in to the front of the aircraft. FIG. 15B provides a rear view of the aircraft showing the aft opening, which allows cargo out of the fuselage, in an open position. The fuselage of the aircraft of FIGS. 14 and 15 is configured such that cargo can be loaded into the fuselage via the front ramp 811, conveyed along the fuselage, and unloaded out of the fuselage via the rear ramp 821. The fuselage may comprise a track configured to facilitate conveyance of cargo along the fuselage. The track may be arranged as described above with reference to FIG. 4.

As shown, for example, in FIG. 11, there are wingtips 21 at the distal ends of the wing 20. In order to provide electrical power during flight, for example to power flight systems, wingtip vortex turbines may be disposed at one or both of the wingtips. Additionally or alternatively, wingtip vortex turbines may be disposed at the wingtips of the horizontal tail wing. The wingtip vortex turbine is preferably retractable. The wingtip vortex turbines 70 may be the same as those described above with reference to FIGS. 7A-B. The aircraft may beneficially require less electrical power than manned aircraft, which require electrical power for systems such as flight controls and air conditioning. This further improves the efficiency of the aircraft.

The aircraft comprises a plurality of flight control surfaces configured to be actuated to adjust the aircraft's flight attitude. The aircraft of FIGS. 11 to 15 optionally comprises discrete actuation mechanisms and electric motors as described above in reference to the aircraft of FIGS. 1 to 10.

The aircraft of FIGS. 11 to 15 may comprise a fuel tank 40, and optionally also a tank controller, configured as described above with reference to FIG. 2 and FIG. 4C. The fuel tank may therefore have sufficient capacity to facilitate long distance flight routes, such as trans-oceanic routes.

The aircraft is preferably suitable for landing on water. The aircraft may have only two engines. As such, there is the possibility of engine failure resulting in the aircraft being unable to reach an airport. In particular, due to the likelihood that the aircraft will be operated on mainly trans-oceanic routes (i.e. over water), it is possible that the aircraft may not be able to reach land in the case of an engine failure. Although complete engine failure is rare in modern turbofan engines, it is nonetheless desirable that the aircraft is suitable for landing (ditching) on water, without sustaining significant damage, such that some or all of the cargo may be retrieved and/or the aircraft may be salvaged for future use after ditching in water.

The underside of the fuselage may be configured for landing on water. In particular, the underside of the aircraft may be configured as described above with reference to FIGS. 8 and 9, to act as a tunnel hull. In particular, as shown for example in FIG. 12, the multi-engine arrangement of the aircraft may comprise protruding sections 101, and a central portion 102. The protruding sections 102 may house the main landing gear wheels 80 of the aircraft via closure of the cover 111. In this way, the protruding sections act as both a landing gear housing and a flotation aid for use in the event of a water landing or ditching. Thus, the aircraft may have the benefit of being simpler and more cost effective to manufacture than an aircraft having separate components for housing the landing gear and enabling water landing.

As described above for the aircraft of FIG. 1, in the aircraft of FIG. 11, the main landing gear may be electrically powered. The aircraft may comprise electric motors configured to drive the wheels 80 of the main landing gear. The powered main landing gear is configured to assist in take-off. That is, the motors supplement the propulsion provided by the engine during the take-off roll, which may in turn reduce the power required by the engines. Because the peak power requirement of the engines is typically during take-off, this may in turn allow a smaller engine to be used for a given aircraft or may allow the number of engines to be less than typical. The powered main landing gear is also desirably configured to allow the aircraft to taxi on the ground without need for jet engine power. This may increase efficiency compared to conventional airliners, which are propelled only by jet engines during taxi. For example, as shown in FIG. 12, the aircraft may comprise battery packs 90, which may be movable as described above with reference to FIG. 10.

The aircraft of FIGS. 11 to 15 optionally comprises a nose landing gear. In some arrangements the nose landing gear may be configured to steer the aircraft, for example during taxiing. Alternatively, or additionally, the main landing gear of the aircraft may be configured to contribute to steering the aircraft. For example, the electric motors of the main landing gear may be controlled to provide different power to wheels on the left of the aircraft than to wheels on the right of the aircraft such that the aircraft turns during taxiing.

Aspects of the present disclosure have been described with particular reference to the examples illustrated. While specific examples are shown in the drawings and are herein described in detail, it should be understood, however, that the drawings and detailed description are not intended to limit the invention to the particular form disclosed. It will be appreciated that variations and modifications may be made to the examples described within the scope of the present invention, as defined by the claims.

1. (canceled)

2. An unmanned aircraft for carrying of cargo, comprising
a fuselage extending in a fore-aft direction and configured to receive cargo in an unpressurized interior space thereof;
a wing extending in a spanwise direction perpendicular to the fore-aft direction; and
a single engine located at or adjacent the rear of the fuselage, wherein the engine is a jet engine;
wherein the aircraft is configured for roll-on/roll-off loading of intermodal cargo containers.

3. The aircraft of claim 2, further comprising
a main landing gear comprising a plurality of wheels,
at least one electric motor configured to drive the wheels of the main landing gear,
and a battery pack configured to power at least one of said electric motors.

4. (canceled)

5. The aircraft of claim 3, further comprising a sled disposed in the fuselage, wherein the battery pack is mounted on the sled, and the sled is configured to move along the fuselage of the aircraft in a fore-aft direction of the fuselage, wherein the sled is controlled to move in a fore-aft direction of the fuselage to vary a center of gravity position of the aircraft.

6. (canceled)

7. The aircraft of claim 2, wherein the underside of the fuselage comprises two protruding sections arranged symmetrically around a center of the fuselage in the spanwise direction, and a central portion between the protruding sections, wherein the protruding sections extend below a lowermost point of the central portion, wherein the aircraft further comprises a main landing gear, wherein the protruding sections are configured to house the main landing gear.

8. (canceled)

9. The aircraft of claim 7, wherein the protruding sections each comprise a cover configured to extend over the wheels of the main landing gear such that in a closed position the wheels are housed in the protruding section; and wherein the cover is configured to retract such that in an open position the wheels are not completely housed within the protruding section, wherein the cover is configured to be rotated, around longitudinal direction of the protruding section, to move between the open position and the closed position.

10. (canceled)

11. The aircraft of claim 3, wherein at least one of:
the main landing gear is non-retractable; and an underside of the fuselage is configured as a tunnel hull for landing on water.

12. (canceled)

13. The aircraft of claim 2, wherein the engine is located aft of the fuselage.

14. The aircraft of claim 2, further comprising an air inlet configured to direct air from a boundary layer of the fuselage into the engine, wherein the air inlet comprises a duct extending around at least 50% of the fuselage in a circumferential direction of the fuselage.

15. (canceled)

16. The aircraft of claim 14, wherein at least one of:
the duct entirely surrounds the fuselage in a circumferential direction of the fuselage; wherein the duct comprises an outlet configured to provide a path for air to exit the duct bypassing the engine, and wherein the outlet is configured to close when the aircraft altitude is within an predetermined altitude range.

17. (canceled)

18. (canceled)

19. The aircraft of claim 2, further comprising a bottom deck and a top deck above the bottom deck in an interior of the fuselage, wherein the fuselage is configured to house a plurality of standard ISO sized containers on the bottom deck, and a plurality of standard ISO sized containers on the top deck.

20. (canceled)

21. The aircraft of claim 19, further comprising
a front ramp disposed at a forward end of the aircraft and configured to allow cargo to be loaded into and/or out of the fuselage; and
a rear ramp disposed at the aft end of the fuselage and configured to allow cargo to be loaded into and/or out of the fuselage, wherein the rear ramp comprises a pair of rear ramps configured to allow cargo to be loaded out of the top deck and/or the bottom deck, and wherein the front ramp comprises a pair of front ramps configured to allow cargo to be loaded into the top deck and/or the bottom deck.

22. (canceled)

23. (canceled)

24. The aircraft of claim 21, wherein the fuselage is configured such that
cargo can be loaded into fuselage via the front ramp, conveyed along the fuselage, and unloaded out of the fuselage via the rear ramp.

25. The aircraft of claim 2, further comprising a lifting mechanism configured to move the top deck between a lowered position and a raised position, wherein in the lowered position the top deck is disposed adjacent the bottom deck and wherein in the raised position the distance between the top deck and the bottom deck is greater than the height of a standard ISO sized container.

26. The aircraft of claim 25, further comprising a middle deck, wherein the middle deck is disposed above the bottom deck and below the top deck in an interior of the fuselage, wherein the lifting mechanism is configured to move the middle deck between a lowered position and a mid-position, wherein in the lowered position, the middle deck is disposed adjacent the bottom deck and wherein in the mid position, the distance between the middle deck and the lower deck is greater than the height of a standard ISO sized container, and the distance between the middle deck and the top deck is greater than the height of a standard ISO sized container.

27. (canceled)

28. The aircraft of claim 2, wherein at least one of:
the fuselage is configured to house two standard ISO sized containers side-by-side in the spanwise direction; and the aircraft further comprises a track disposed inside the fuselage on a floor of the fuselage, wherein the track extends in a longitudinal direction of the fuselage and is configured to facilitate conveyance of cargo along the fuselage.

29. (canceled)

30. The aircraft of claim 2, further comprising
a wingtip at a distal end of the wing;
an electrical generator; and
a wingtip vortex turbine disposed at the wingtip and configured to rotate to turn the electrical generator; wherein the wingtip vortex turbine comprises:
a plurality of turbine blades;
a rod; and
a collar circumferentially surrounding the rod and configured to slide between a first end of the rod and a second end of the rod, in a longitudinal direction of the rod;
wherein the turbine blades each comprise a root and a tip, and wherein the collar is connected to the turbine blades at the root of the turbine blades;
wherein the wingtip vortex turbine is configured such that:
in an deployed position, with the collar at the first end of the rod, the turbine blades extend out from the first end of the rod such that the tips of the turbine blades are a maximum distance from the rod in a radial direction of the rod, and
in a retracted position, with the collar at the second end of the rod, the turbine blades extend alongside the rod such that the tips of the turbine blades are adjacent the first end of the rod.

31. (canceled)

32. The aircraft of claim 2, wherein at least one of:
the wing is disposed in a high wing configuration;, and the aircraft further comprises a bracing strut connecting the wing to the fuselage, wherein the bracing strut contacts an underside of the wing at a position in a central region of the wing, wherein the central region is a central third of the wing between the fuselage and the tip of the wing; and the aircraft further comprises:
a plurality of flight control surfaces, and
a plurality of electric motors configured to actuate the control surfaces, wherein each electric motor is disposed within a predetermined range of the corresponding flight control surface.

33. (canceled)

34. The aircraft of claim 2, further comprising
a fuel tank comprising an inner layer configured to contain fluid, and an outer layer surrounding the inner layer; and
a tank controller configured to control the differential pressure of the outer layer based on fuel tank parameters, wherein the fuel tank parameters include at least one of rate of fuel flow from the fuel tank and pressure in the inner layer.

35. The aircraft of claim 34, wherein
the fuel tank comprises two lobes set fore-and-aft of each other and configured to allow the fluid to travel between the lobes, and
the tank controller is configured to control the differential pressure of the outer layer to balance the amount of fluid in each of the two lobes.

36. An unmanned aircraft for carrying of cargo, comprising
a fuselage extending in a fore-aft direction and configured to receive cargo in an unpressurized interior space thereof;
a bottom deck and a top deck above the bottom deck in an interior of the fuselage;
a wing extending in a spanwise direction perpendicular to the fore-aft direction; and
a plurality of engines, wherein the engines are jet engines;
wherein the aircraft is configured for roll-on/roll-off loading of intermodal cargo containers.
